(19) United States
(12) Patent Application Publication
(10) Pub. No.: US 2026/0257541 A1
(43) Pub. Date: Sep. 3, 2026

(54) VEHICLE DOOR MODULE STORAGE SYSTEM

(71) Applicant: Ford Global Technologies, LLC, Dearborn, MI (US)

(72) Inventors: Michael John Harmon, Northville, MI (US); Darren Luke, West Bloomfield, MI (US); Robert J. Gelardi, Plymouth, MI (US); Justin D. Sorum, Royal Oak, MI (US); Ricardo Haruo Sugimoto, Camaçari (BR); Abbas Ghamlouche, Dearborn, MI (US)

(21) Appl. No.: 19/066,662

(22) Filed: Feb. 28, 2025

(51) Int. Cl. B60J 5/04; B60R 11/00

(52) U.S. Cl. CPC B60J 5/0468; B60J 5/0415; B60J 5/0416; B60J 5/0487; B60R 11/00; B60R 2011/0036; B60R 2011/005

(57) ABSTRACT

A vehicle door module storage system includes a support beam that engages with a vehicle. The support beam is configured to support an outer module of a door assembly within a cargo area. The door assembly can have the outer module and an inner module. The door assembly can be changeable back-and-forth between a first configuration and a second configuration. In the first configuration, the door assembly is provided by the inner module coupled to the outer module. In the second configuration, the door assembly is provided by the inner module without the outer module.

### TECHNICAL FIELD

This disclosure relates generally to storing door modules of a vehicle.

### BACKGROUND

Some vehicles, particularly off-road vehicles, have removeable doors. In such vehicles, a user can remove at least a portion of an original door from a body of the vehicle—the portion can be considered a module of the original door. The user can then operate the vehicle with the portion of the original door removed to provide the user with a more open-air driving experience.

### SUMMARY

In some aspects, the techniques described herein relate to a vehicle door module storage system, including: a support beam that engages with a vehicle, the support beam configured to support an outer module of a door assembly within a cargo area.

In some aspects, the techniques described herein relate to a vehicle door module storage system, further including the door assembly having the outer module and an inner module, the door assembly changeable back-and-forth between a first configuration and a second configuration, in the first configuration, the door assembly is provided by the inner module coupled to the outer module, in the second configuration, the door assembly is provided by the inner module without the outer module.

In some aspects, the techniques described herein relate to a vehicle door module storage system, wherein the outer module is configured to attach to the support beam when the door assembly is in the second configuration.

In some aspects, the techniques described herein relate to a vehicle door module storage system, wherein the outer module is a door skin having a channel that receives the inner module when the door assembly is in the first configuration.

In some aspects, the techniques described herein relate to a vehicle door module storage system, wherein the support beam is received within the channel of the outer module when the door assembly is in the second configuration and the support beam is supporting the outer module.

In some aspects, the techniques described herein relate to a vehicle door module storage system, further including an outer module connection interface of the outer module that engages with an inner module connection interface to couple the outer module to the inner module when the door assembly is in the first configuration.

In some aspects, the techniques described herein relate to a vehicle door module storage system, wherein support beam includes a support beam connection interface that engages with the outer module connection interface to couple the outer module to the support beam when the door assembly is in the second configuration.

In some aspects, the techniques described herein relate to a vehicle door module storage system, wherein the support beam connection interface is substantially identical to the inner module connection interface.

In some aspects, the techniques described herein relate to a vehicle door module storage system, wherein the door assembly in the first configuration is configured to cover more of a door opening area than the door assembly in the second configuration.

In some aspects, the techniques described herein relate to a vehicle door module storage system, wherein the support beam is a first support beam and the door assembly is a driver side door assembly, and further including a second support beam that engages with the vehicle and is configured to support an outer module of a passenger side door assembly.

In some aspects, the techniques described herein relate to a vehicle door module storage system, wherein the driver side door assembly is a front driver side door assembly, and the passenger side door assembly is a front passenger side door assembly, and further including a third support beam and a fourth support beam, wherein the third support beam engages with the vehicle and is configured to support an outer module of a rear driver side door assembly, wherein the fourth support beam engages with the vehicle and is configured to support an outer module of a passenger side door assembly.

In some aspects, the techniques described herein relate to a vehicle door module storage system, wherein the support beam spans from a driver side sidewall of the vehicle to a passenger side sidewall of the vehicle with the support beam engages with the vehicle.

In some aspects, the techniques described herein relate to a vehicle door module storage system, wherein the support beam is slidably received within a slot of the driver side sidewall and a slot of the passenger side sidewall when the support beam engages with the vehicle.

In some aspects, the techniques described herein relate to a vehicle door module storage system, wherein the outer module includes a door window.

In some aspects, the techniques described herein relate to a vehicle door module storage system, wherein the door assembly is a removable door assembly.

In some aspects, the techniques described herein relate to a vehicle door module storage system, including: a door assembly of a vehicle, the door assembly having an outer module and an inner module, the door assembly changeable back-and-forth between a first configuration and a second configuration, in the first configuration, the door assembly is provided by the inner module coupled to the outer module, in the second configuration, the door assembly is provided by the inner module without the outer module, the outer module configured to engages with a support beam when the door assembly is in the second configuration, the support beam engaged with the vehicle.

In some aspects, the techniques described herein relate to a vehicle door module storage system, wherein the outer module is a door skin having a channel that receives the inner module when the door assembly is in the first configuration.

In some aspects, the techniques described herein relate to a vehicle door module storage system, wherein the support beam is received within the channel of the outer module when the door assembly is in the second configuration and the support beam is supporting the outer module.

In some aspects, the techniques described herein relate to a vehicle door module storage system, wherein the support beam is a first support beam and the door assembly is a driver side door assembly, and further including a second support beam that engages with the vehicle and is configured to support an outer module of a passenger side door assembly.

In some aspects, the techniques described herein relate to a vehicle door module storage system, further including an outer module connection interface of the outer module that engages with an inner module connection interface to couple the outer module to the inner module when the door assembly is in the first configuration, wherein support beam includes a support beam connection interface that engages with the outer module connection interface to couple the outer module to the support beam when the door assembly is in the second configuration.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of a vehicle having a plurality of vehicle door assemblies each in a first configuration.

FIG. 2 illustrates the side view of the vehicle of FIG. 1 with the plurality of vehicle door assemblies each in a second configuration.

FIG. 3 illustrates a perspective view of the vehicle of FIG. 2 with the vehicle door assemblies changed to the different, second configuration.

FIG. 4 illustrates a support beam according to an exemplary embodiment of the present disclosure moving to an engaged position with the vehicle of FIGS. 1-3 with portions of the vehicle removed to show more of a cargo area of the vehicle.

FIG. 5A illustrates a support beam of the vehicle in a retracted position.

FIG. 5B illustrates the support beam of FIG. 5A in an extended position according to the exemplary aspect of the present disclosure.

FIG. 6 illustrates the support beam and vehicle of FIG. 5B when the support beam is engaged with the vehicle of FIG. 4 and a user is transporting an outer module of a door assembly toward the cargo area.

FIG. 7 illustrates the support beam of FIG. 5B supporting an inner module of a door assembly along with three other support beams and inner modules of three other door assemblies.

FIG. 8 illustrates the support beam of FIG. 5A in the retracted positions and stowed within the cargo area of the vehicle.

### DETAILED DESCRIPTION

A door assembly of a vehicle can include an outer module and an inner module that can be latched together under some operating conditions. Under other operations, such as when a more open-air experience is desired, the outer module can be separated from the inner module and stored. Exemplary aspects of this disclosure relate to storing the outer module by securing the outer module to a support beam within a cargo area of the vehicle.

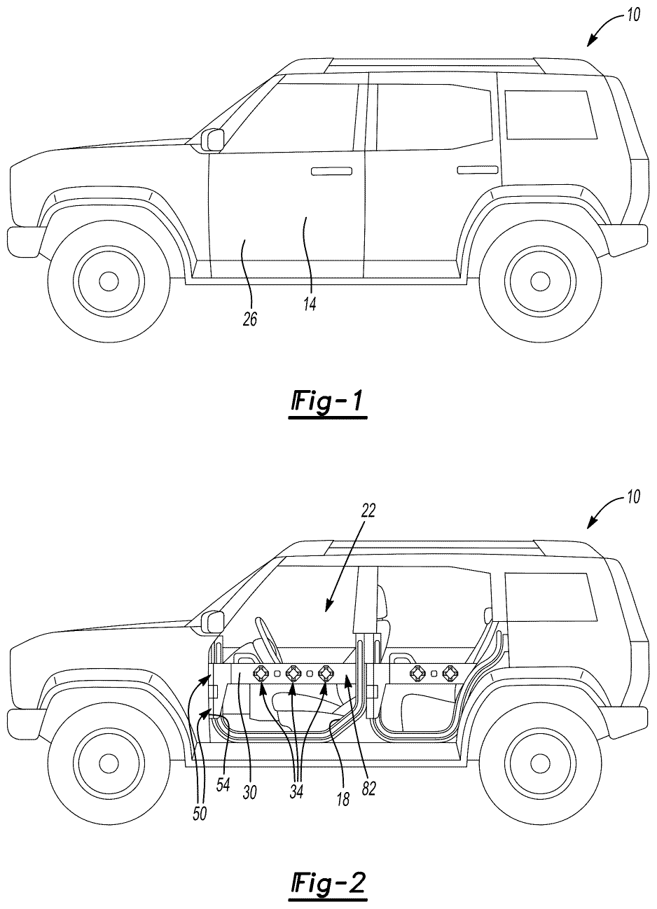

Referring to FIGS. 1 and 2, a vehicle 10 includes a door assembly 14 that is disposed within a door opening 18. The door assembly 14 is a driver side front door assembly. The exemplary vehicle 10 includes three additional vehicle door assemblies: a driver side rear door assembly, and front and rear door assemblies on a passenger side of the vehicle 10.

In FIG. 1, the door assembly 14 is in a first configuration and in a closed position. When in the first configuration and closed position, the door assembly 14 substantially covers the door opening 18 to help enclose a passenger compartment 22 of the vehicle 10.

In FIG. 2, the door assembly 14 is in a second configuration and in a closed position. When in the second configuration and closed position as shown, the door assembly 14 partially covers the door opening 18, which can provide a user within the passenger compartment 22 with a partial open-air experience. The door assembly 14 in the first configuration and the closed position covers more of the door opening 18 than the door assembly 14 in the second configuration. The door assembly 14 is changeable back-and-forth between the first configuration and the second configuration.

The door assembly 14 can be a removeable door assembly. The door assembly 14 includes, in the exemplary embodiment, an outer module 26 or door skin, and an inner module 30. When in the first configuration shown in FIG. 1, the outer module 26 and the inner module 30 are connected together. When in the second configuration of FIG. 2, the outer module 26 is disconnected from the inner module 30, and the door assembly 14 is provided by the inner module 30 without the outer module 26. In some examples, the inner module 30 could also be removed from the vehicle 10.

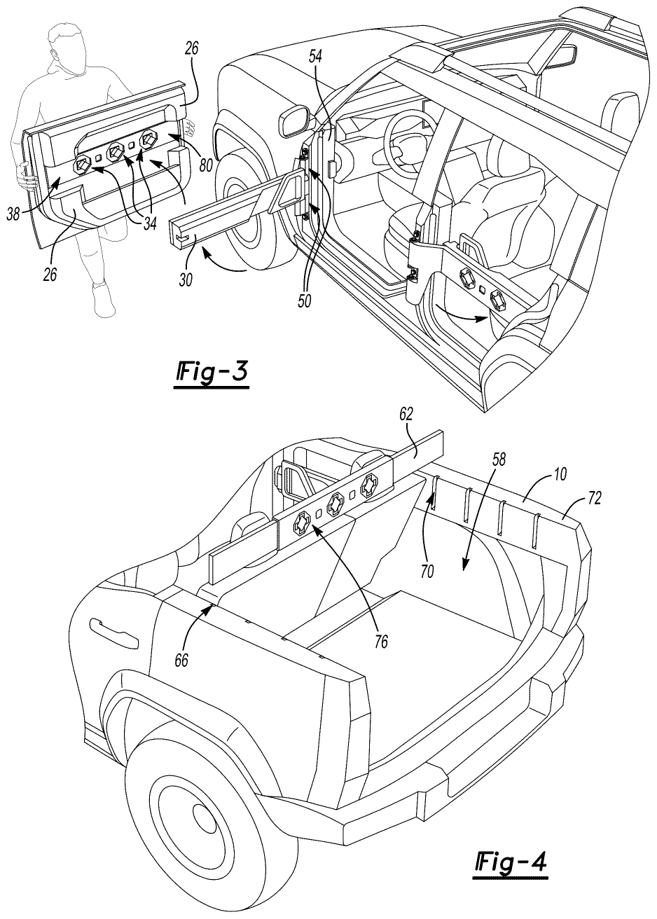

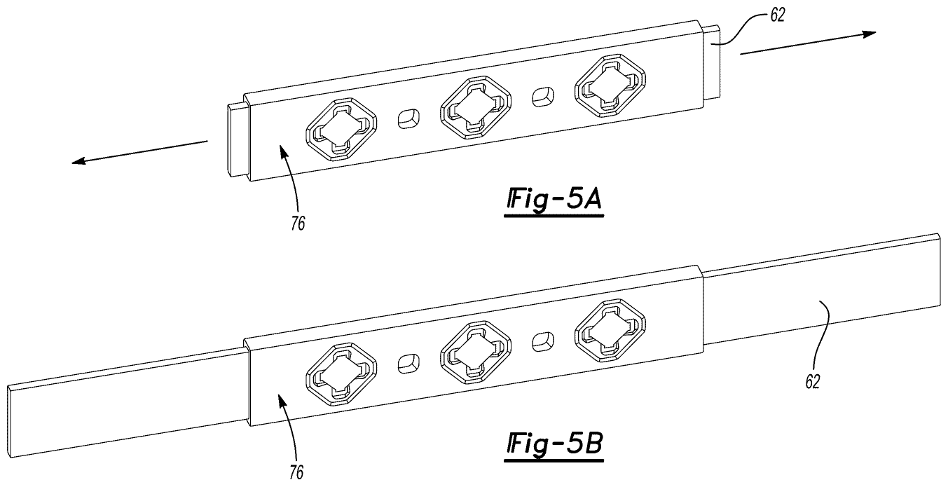

With reference now to FIGS. 3 and 4 and continuing reference to FIGS. 1 and 2, the outer module 26 can be latched to the inner module 30 via at least one latch assembly 34. In an example, the at least one latch assembly 34 can rely on feet that are received within apertures of a locking grid, such as the locking grid of the GRIDRACK™ system.

When in the first configuration, the inner module 30 is received within a channel 38 of the outer module 26. The at least one latch assembly 34 is disposed in areas where the inner module 30 interfaces with the walls of the channel 38.

In some examples, the latches that connect the outer module 26 to the inner module 30 can comprises e-latches that can be activated to unlock the outer module 26 from the inner module 30 only when the vehicle 10 is in a stationary position and in a parked gear. This can help to ensure that the outer module 26 only unlocks relative to the inner module 30 only when the vehicle 10 is locked in a stationary position.

To change the door assembly 14 from the first configuration to the second configuration, a user can unlatch the outer module 26 from the inner module 30 and then remove the outer module 26 from the inner module 30. The remaining doors of the vehicle 10 are configured similarly to the door assembly 14 and are able to be changed back-and-forth between the first configuration with an inner module coupled to an outer module, and a second configuration that only uses the inner module to provide a door assembly.

In this example, the outer module 26 includes a window of the door assembly 14. The majority of the mechanisms and electronics associated with the door assembly 14 reside within the inner module 30. This can reduce weight and complexity of the outer module 26, which can facilitate separating the outer module 26 from the inner module 42. The user is not required to lift the mechanism and electronics within the inner module 30 when changing the door assembly 14 from the first configuration to the second configuration.

Hinges 50 connect the door assembly 14 in the first configuration to a vehicle body 54 of the vehicle 10. The same hinges 50 connect the door assembly 14 in the second configuration to the vehicle body 54. The door assembly 14 can pivot about the hinges 50 back-and-forth between the closed position and an open position when the door assembly 14 is in the first configuration and when the door assembly 14 is in the second configuration.

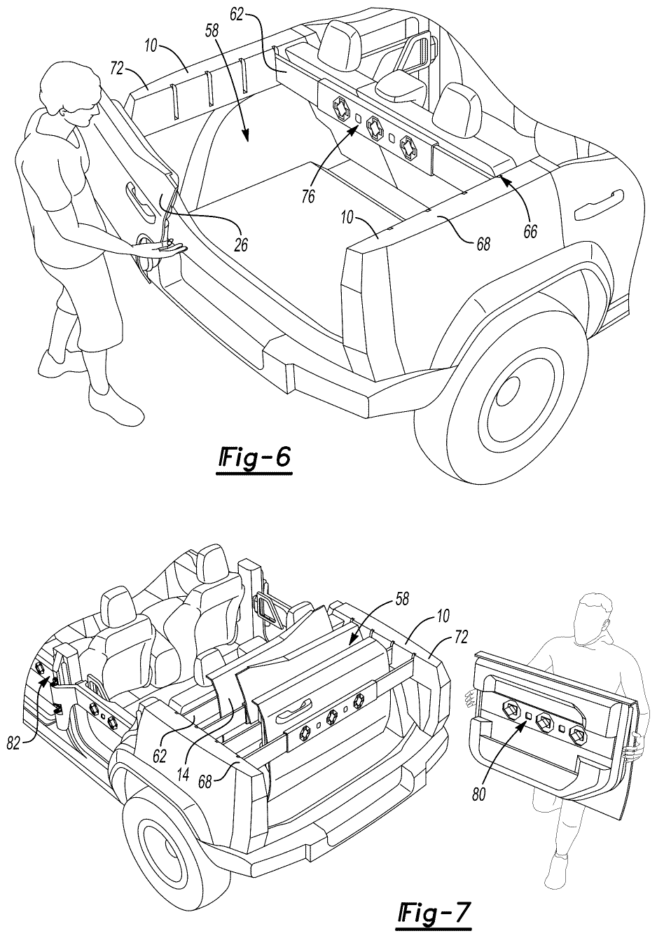

Referring now to FIGS. 4-8, when the door assembly 14 is in the second configuration where the outer module 26 is decoupled from the inner module 30, the vehicle 10 is equipped to transport the outer module 26 of the door assembly 14. The vehicle 10 can transport the outer module 26 within a cargo area 58 of the vehicle 10. The vehicle 10 can transport the outer module 26 within the cargo area 58, along with the outer modules of the remaining doors of the vehicle 10. In the exemplary embodiment, the vehicle 10 uses a support beam 62 within the cargo area 58 when transporting the outer module 26. The support beam 62 can each couple the outer modules 26 of the vehicle 10.

The support beams 62 are configured to move from a retracted position as shown in FIG. 5A to an extend position as shown in FIG. 5B. When the support beam 62 is in the extended position of FIG. 5B, the support beam 62 can be positioned within the cargo area 58 such that the support beam 62 engages with the vehicle 10.

In this example, a longitudinal end portion of the support beam 62 is received within a slot 66 on a driver side sidewall 68 of the vehicle when engaging the vehicle 10. An opposite second end portion of the support beam 62 is received within another slot 70 on a passenger side sidewall 72 of the vehicle 10 when the support beam 62 is engaging the vehicle 10. The slots 66 and 70 each open upward within the cargo area 58 to facilitate insertion of the support beam 62 into the slots 66 and 70. The support beams 62 are slidably received within corresponding slots 66 and 70.

As shown, the driver side of the cargo area includes the slot 66 along with three other slots, and the passenger side of the cargo area 58 includes the slot 70 along with three other slots. The cargo area 58 is thus equipped to engage with the support beam 62 and three other support beams spaced from each other along a central axis of the vehicle 10.

In this example, the support beams 62 supports the outer module 26 of the door assembly 14. The remaining support beams can support the remaining outer modules of the other doors of the vehicle 10. The support beams 62 support the outer module 26 and the remaining outer modules at a position spaced from each other.

The outer module 26 is configured to attach to the support beam 62 when stowed within the cargo area 58. Attachment of the outer module 26 to the support beam 62 can secure the outer module 26 during transport and the vehicle 10 is moved. In this example, the support beam 62 provides apertures of a locking grid that mimics the apertures of the locking grid provided on the inner module 30. The support beam 62 fits with within the channel 38 of the outer module 26 when the outer module 26 is secured to the support beam 62, and feet of the outer module 26 are received within the apertures on the support beams 62.

In the exemplary embodiment, the locking grid of the support beam 62 is a connection interface 76 that engages with a corresponding connection interface 80 of the outer module 26 as the support beam 62 is received within the channel 38 on the outer module 26.

The connection interface 80 of the outer module 26 is also configured to selectively engage with a corresponding connection interface 82 of the inner module 30. The connection interface provided by the support beam 62 is substantially identical to the connection interface 82 of the inner module 30.

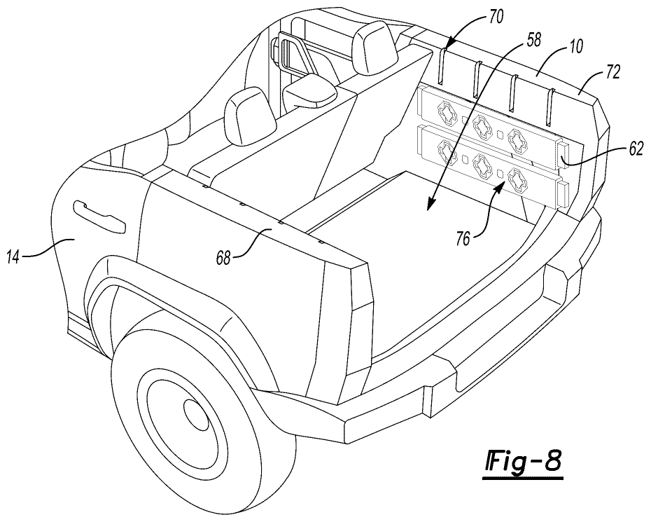

When the door assembly 14 and the remaining door assemblies are in the first configuration of FIG. 1, the support beam 62 and the other support beams can be move to the retracted positions and hung from the sidewall 68 or 72 as shown in FIG. 8, or stored elsewhere within the vehicle 10. The support beam 62 extends from and retracts within the connection interface 76 of the support beam 62.

Features of the disclosed examples include a door module storage system that can hold multiple door modules in positions spaced apart from each other. As the door modules are spaced from each other and secured in place during transport, protective bags enclosing the door modules may not be required. The storage system can hold the doors to prevent jostling and inadvertent rubbing against other components.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A vehicle door module storage system, comprising:
a support beam that engages with a vehicle, the support beam configured to support an outer module of a door assembly within a cargo area.

2. The vehicle door module storage system of claim 1, further comprising the door assembly having the outer module and an inner module, the door assembly changeable back-and-forth between a first configuration and a second configuration,
in the first configuration, the door assembly is provided by the inner module coupled to the outer module, in the second configuration, the door assembly is provided by the inner module without the outer module.

3. The vehicle door module storage system of claim 2, wherein the outer module is configured to attach to the support beam when the door assembly is in the second configuration.

4. The vehicle door module storage system of claim 2, wherein the outer module is a door skin having a channel that receives the inner module when the door assembly is in the first configuration.

5. The vehicle door module storage system of claim 4, wherein the support beam is received within the channel of the outer module when the door assembly is in the second configuration and the support beam is supporting the outer module.

6. The vehicle door module storage system of claim 2, further comprising an outer module connection interface of the outer module that engages with an inner module connection interface to couple the outer module to the inner module when the door assembly is in the first configuration.

7. The vehicle door module storage system of claim 6, wherein support beam includes a support beam connection interface that engages with the outer module connection interface to couple the outer module to the support beam when the door assembly is in the second configuration.

8. The vehicle door module storage system of claim 7, wherein the support beam connection interface is substantially identical to the inner module connection interface.

9. The vehicle door module storage system of claim 2, wherein the door assembly in the first configuration is configured to cover more of a door opening area than the door assembly in the second configuration.

10. The vehicle door module storage system of claim 1, wherein the support beam is a first support beam and the door assembly is a driver side door assembly, and further comprising a second support beam that engages with the vehicle and is configured to support an outer module of a passenger side door assembly.

11. The vehicle door module storage system of claim 10, wherein the driver side door assembly is a front driver side door assembly, and the passenger side door assembly is a front passenger side door assembly, and further comprising a third support beam and a fourth support beam, wherein the third support beam engages with the vehicle and is configured to support an outer module of a rear driver side door assembly, wherein the fourth support beam engages with the vehicle and is configured to support an outer module of a passenger side door assembly.

12. The vehicle door module storage system of claim 1, wherein the support beam spans from a driver side sidewall of the vehicle to a passenger side sidewall of the vehicle with the support beam engages with the vehicle.

13. The vehicle door module storage system of claim 12, wherein the support beam is slidably received within a slot of the driver side sidewall and a slot of the passenger side sidewall when the support beam engages with the vehicle.

14. The vehicle door module storage system of claim 1, wherein the outer module includes a door window.

15. The vehicle door module storage system of claim 1, wherein the door assembly is a removable door assembly.

16. A vehicle door module storage system, comprising:
a door assembly of a vehicle, the door assembly having an outer module and an inner module, the door assembly changeable back-and-forth between a first configuration and a second configuration,
in the first configuration, the door assembly is provided by the inner module coupled to the outer module,
in the second configuration, the door assembly is provided by the inner module without the outer module, the outer module configured to engages with a support beam when the door assembly is in the second configuration, the support beam engaged with the vehicle.

17. The vehicle door module storage system of claim 16, wherein the outer module is a door skin having a channel that receives the inner module when the door assembly is in the first configuration.

18. The vehicle door module storage system of claim 17, wherein the support beam is received within the channel of the outer module when the door assembly is in the second configuration and the support beam is supporting the outer module.

19. The vehicle door module storage system of claim 18, wherein the support beam is a first support beam and the door assembly is a driver side door assembly, and further comprising a second support beam that engages with the vehicle and is configured to support an outer module of a passenger side door assembly.

20. The vehicle door module storage system of claim 16, further comprising an outer module connection interface of the outer module that engages with an inner module connection interface to couple the outer module to the inner module when the door assembly is in the first configuration, wherein support beam includes a support beam connection interface that engages with the outer module connection interface to couple the outer module to the support beam when the door assembly is in the second configuration.
